(19) United States
(12) Patent Application Publication
(10) Pub. No.: US 2026/0339507 A1
(43) Pub. Date: Oct. 29, 2026

(54) CONTROL METHOD AND APPARATUS, DEVICE, AND COMPUTER-READABLE STORAGE MEDIUM

(71) Applicant: Tencent Technology (Shenzhen) Company Limited, Shenzhen (CN)

(72) Inventors: Jiani WANG, Shenzhen (CN); Dandan Du, Shenzhen (CN)

(73) Assignee: Tencent Technology (Shenzhen) Company Limited, Shenzhen (CN)

(21) Appl. No.: 19/341,356

(22) Filed: Sep. 26, 2025

Related U.S. Application Data
(63) Continuation of application No. PCT/CN2024/102956, filed on Jul. 1, 2024.

(30) Foreign Application Priority Data
Nov. 28, 2023 (CN) 202311608837.X

(51) Int. Cl. G06F 3/04886; A63F 13/22; G06F 3/04815; G06F 3/04845

(52) U.S. Cl. CPC G06F 3/04886; A63F 13/22; G06F 3/04815; G06F 3/04845

(57) ABSTRACT

A control method of a terminal device includes displaying, by a terminal device, a virtual environment picture including a direction control for controlling movement of a virtual object in a virtual environment, the direction control being displayed in a first display mode corresponding to a non-static step moving mode of the virtual object in the virtual environment; and based on determining that an operation distance derived from a target gesture operation applied via the direction control is not greater than a static step range threshold, displaying the direction control in an adjusted display mode in response to the target gesture operation, the adjusted display mode corresponding to a static step moving mode of the virtual object in the virtual environment.

### CROSS-REFERENCE TO RELATED APPLICATIONS

This application is a continuation application of International Application No. PCT/CN2024/102956 filed on Jul. 1, 2024, which claims priority to Chinese Patent Application No. 202311608837.X filed with the China National Intellectual Property Administration on Nov. 28, 2023, the disclosures of each being incorporated by reference herein in their entireties.

### FIELD

The disclosure relates to the field of computer technologies, and to a control method and apparatus, a device, and a computer-readable storage medium.

### BACKGROUND

With the continuous development of computer technologies, there are increasing types of games running on terminal devices. A virtual object in a game may move in a virtual environment in a plurality of moving modes, and a static step mode is one of the moving modes.

### SUMMARY

Provided are a control method and apparatus, a device, and a computer-readable storage medium capable of improving the accuracy of determining a moving mode of a virtual object in a virtual environment and the control of the virtual object.

According to an aspect of the disclosure, a control method of a terminal device includes displaying, by a terminal device, a virtual environment picture including a direction control for controlling movement of a virtual object in a virtual environment, the direction control being displayed in a first display mode corresponding to a non-static step moving mode of the virtual object in the virtual environment; and based on determining that an operation distance derived from a target gesture operation applied via the direction control is not greater than a static step range threshold, displaying the direction control in an adjusted display mode in response to the target gesture operation, the adjusted display mode corresponding to a static step moving mode of the virtual object in the virtual environment.

According to an aspect of the disclosure, a control apparatus includes at least one memory configured to store program code; and at least one processor configured to read the program code and operate as instructed by the program code, the program code including first display code configured to cause at least one processor of the at least one processor to display a virtual environment picture including a direction control for controlling movement of a virtual object in a virtual environment, the direction control being displayed in a first display mode corresponding to a non-static step moving mode of the virtual object in the virtual environment; and second display code configured to cause at least one processor of the at least one processor to, based on determining that an operation distance derived from a target gesture operation applied via the direction control is not greater than a static step range threshold, display the direction control in an adjusted display mode in response to the target gesture operation, the adjusted display mode corresponding to a static step moving mode of the virtual object in the virtual environment.

According to an aspect of the disclosure, a non-transitory computer-readable storage medium, storing computer code which, when executed by at least one processor, causes the at least one processor to at least display a virtual environment picture including a direction control for controlling movement of a virtual object in a virtual environment, the direction control being displayed in a first display mode corresponding to a non-static step moving mode of the virtual object in the virtual environment; and based on determining that an operation distance derived from a target gesture operation applied via the direction control is not greater than a static step range threshold, display the direction control in an adjusted display mode in response to the target gesture operation, the adjusted display mode corresponding to a static step moving mode of the virtual object in the virtual environment.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of some embodiments of a control method according to some embodiments.

FIG. 2 is a flowchart of a control method according to some embodiments.

FIG. 3 is a schematic diagram of display of a virtual environment picture according to some embodiments.

FIG. 4 is a schematic diagram of display of another virtual environment picture according to some embodiments.

FIG. 5 is a schematic diagram of display of another virtual environment picture according to some embodiments.

FIG. 6 is a schematic diagram of display of another virtual environment picture according to some embodiments.

FIG. 7 is a schematic diagram of display of another virtual environment picture according to some embodiments.

FIG. 8 is a schematic diagram of display of another virtual environment picture according to some embodiments.

FIG. 9 is a schematic diagram of display of another virtual environment picture according to some embodiments.

FIG. 10 is a schematic diagram of display of another virtual environment picture according to some embodiments.

FIG. 11 is a flowchart of a control method according to some embodiments.

FIG. 12 is a flowchart of a control method according to some embodiments.

FIG. 13 is a schematic diagram of a structure of a control apparatus according to some embodiments.

FIG. 14 is a schematic diagram of a structure of a terminal device according to some embodiments.

FIG. 15 is a schematic diagram of a structure of a server according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

The terms “module[s]” or “unit[s]” may refer to hardware logic, a processor or processors executing computer software code, or a combination of both. The “modules” or “units” may also be implemented in software stored in a memory of a computer or a non-transitory computer-readable medium, where the instructions of each unit are executable by a processor to thereby cause the processor to perform the respective operations of the corresponding module or unit.

Each module or unit may exist respectively or be combined into one or more units. Some modules or units may be further split into multiple smaller function subunits, thereby implementing the same operations without affecting the technical effects of some embodiments. The modules or units are divided based on logical functions. In actual applications, a function of one module or unit may be realized by multiple modules or units, or functions of multiple modules or units may be realized by one module or unit. In some embodiments, the apparatus may further include other modules or units. In actual applications, these functions may also be realized cooperatively by the other modules or units, and may be realized cooperatively by multiple modules or units.

A computer vision (CV) technology is a field of science that studies how to use a machine to “see”, and that uses a camera and a computer to replace human eyes to perform machine vision such as recognition and measurement on a target, and further perform graphic processing, so that the computer processes the target into an image for human eyes to observe, or an image transmitted to an instrument for detection. As a scientific discipline, computer vision studies related theories and technologies and attempts to establish an artificial intelligence system that can obtain information from images or multidimensional data. Large model technologies bring an important change to development of the computer vision technology. Pre-training models in vision fields such as a swin-transformer (a model for image classification and target detection), a vision transformer (ViT, a model for image classification), vision mixture of experts (V-MOE, a new visual architecture based on sparse mixture of experts), and masked autoencoders (MAE, a self-supervised learning method) may be quickly and widely applied to specific downstream tasks after fine tune. The computer vision technology may include technologies such as image processing, image recognition, image semantic understanding, image retrieval, optical character recognition (OCR), video processing, video semantic understanding, video content/behavior recognition, three-dimensional object reconstruction, a three dimension (3D) technology, virtual reality, augmented reality, synchronous positioning, and map construction, and further includes common biometric feature recognition technologies such as face recognition and fingerprint recognition.

A static step mode means that in a virtual environment, a virtual object moves slowly and makes no sound.

A fixed direction control refers to a type of direction control. A user interface (UI) of the direction control is fixed at a default location without moving, and does not change as a location of a hand changes. When the hand is located in a direction of the direction control, the virtual object walks toward the direction.

A follower direction control refers to another type of direction control. A location pressed by a finger is used as a center of the direction control. When the finger slides toward a direction, a virtual object walks toward the direction. A UI of the direction control is still displayed at a default location, and only a moving direction of the virtual object is displayed.

A virtual environment is an environment provided (displayed) when an application runs on a terminal device. The virtual environment is created for a virtual object to conduct activities. It may be two-dimensional, 2.5-dimensional, three-dimensional, or the like. It may be a simulated environment of the real world, a semi-simulated environment of the real world, or a completely fictional environment. For example, the virtual environment mentioned in some embodiments is three-dimensional.

A virtual object is a movable object in a virtual environment. The movable object may be a virtual person, a virtual animal, a cartoon character, or the like. A user may manipulate the virtual object through a peripheral component or by clicking/tapping a touch display screen. Each virtual object has a shape and size in the virtual environment, and occupies some space in the virtual environment. For example, when the virtual environment is a three-dimensional virtual environment, the virtual object is a three-dimensional model created based on a skeletal animation technology.

A third-person perspective is a perspective from which a camera may see, in a virtual environment and at a position behind a virtual object controlled by a user, the virtual object controlled by the user and elements in a surrounding environment.

A first-person perspective means that a virtual environment is displayed from a subjective perspective of a user.

In a related technology, a game picture is displayed, the game picture includes a direction control, and the direction control is configured to control a virtual object to move in a virtual environment. An operation distance corresponding to a target gesture operation is determined in response to the target gesture operation for the direction control. The virtual environment is controlled, based on that the operation distance is less than a static step range threshold, to generate a slight shake, so that a user determines that a moving mode of the virtual object in the virtual environment is a static step mode. The virtual environment is controlled, based on that the operation distance is not less than the static step range threshold, to generate a large shake, so that a user determines that a moving mode of the virtual object in the virtual environment is not a static step mode. The user can perceive the moving mode of the virtual object in the virtual environment only based on a shaking degree of the virtual environment, so that accuracy of the determined moving mode of the virtual object is low. For such games as precise aiming and short-time shooting, shaking of the virtual environment affects shooting precision of the user. To ensure the shooting precision of the user, in such games, the virtual environment does not shake as the virtual object moves. The user does not perceive the moving mode of the virtual object in the virtual environment. Because the user may control the virtual object based on the moving mode of the virtual object, an effect of controlling the virtual object by the user is poor.

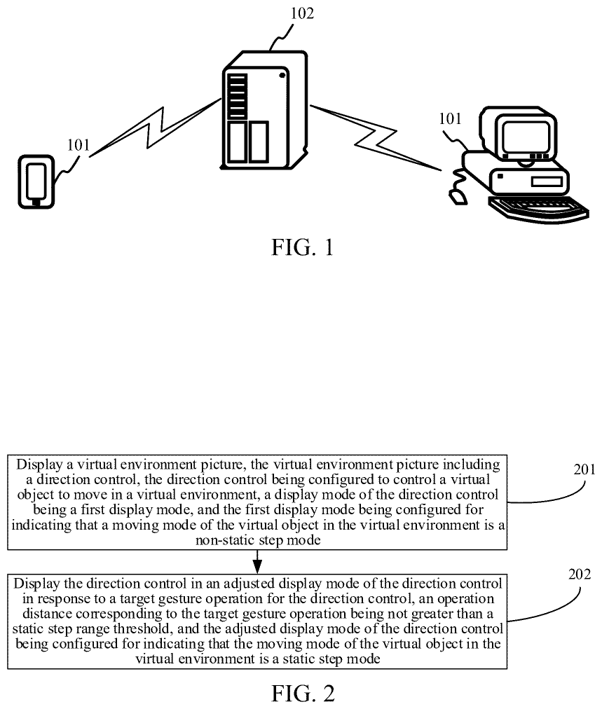

FIG. 1 is a schematic diagram of a control method according to some embodiments. As shown in FIG. 1, some embodiments may include a terminal device 101 and a server 102. A client that can provide a virtual environment is installed and run in the terminal device 101. The terminal device 101 is configured to perform the control method. The client may be of multiple types. For example, a game client may provide the virtual environment for a user to play a game; a teaching client may provide the virtual environment for online courses; a live stream client may provide the virtual environment for performing an operation while watching a live stream; or a chat client may provide the virtual environment for presenting chat messages with a friend in the virtual environment. A type of the client is not limited in some embodiments.

For example, the client that can provide the virtual environment may be a third-person shooting (TPS) game, a first-person shooting (FPS) game, a multiplayer online battle arena (MOBA) game, a multiplayer shooting survival game, a massive multiplayer online (MMO) role-playing game, an action role-playing game (ARPG), a virtual reality (VR) client, an augmented reality (AR) client, a three-dimensional map program, a map simulation program, a social client, an interactive entertainment client, and the like.

The server 102 is configured to provide a back-end service for the client that can provide the virtual environment and that is installed in the terminal device 101. In some embodiments, the server 102 may take on primary computing work while the terminal device 101 takes on secondary computing work, or conversely, the terminal device 101 may take on primary computing work while the server 102 takes on secondary computing work. Collaborative computing may be performed between the server 102 and the terminal device 101 by using a distributed computing architecture.

In some embodiments, the terminal device 101 may be any electronic device product that may perform human-machine interaction with the user in one or more manners of a keyboard, a touch pad, a remote control, voice interaction, a handwriting device, or the like. For example, the terminal device 101 may be a smartphone, a tablet computer, a notebook computer, a desktop computer, a smart speaker, a smart watch, a personal computer (PC), a mobile phone, a personal digital assistant (PDA), a wearable device, a pocket personal computer (PPC), a smart on board unit, a smart television, or the like.

The terminal device 101 may refer to one of a plurality of terminal devices. In some embodiments, the terminal device 101 is used as an example for description. A person skilled in the art can learn that there may be more or fewer terminal devices 101. For example, there is only one terminal device 101, or there are dozens or hundreds of terminal devices 101, or more terminal devices 101. A quantity of terminal devices 101 and a device type are not limited.

The server 102 may be one server, a server cluster including a plurality of servers, or either of a cloud computing platform or a virtualization center. However, the disclosure is not limited thereto. The server 102 and the terminal device 101 are directly or indirectly communicatively connected in a wired or wireless communication manner. The server 102 has a data receiving function, a data processing function, and a data transmitting function. The server 102 may also have another function. However, the disclosure is not limited thereto.

A person skilled in the art is to understand that the terminal device 101 and the server 102 are only examples for description, and other existing or future possible terminal devices or servers that are applicable are also to be included in the protection scope, and are included herein by reference.

Some embodiments provide a control method applicable to FIG. 1. A flowchart of the control method shown in FIG. 2 is used as an example, and the method may be performed by the terminal device 101. As shown in FIG. 2, the method includes operation 201 and operation 202.

Operation 201: Display a virtual environment picture, the virtual environment picture including a direction control, the direction control being configured to control a virtual object to move in a virtual environment, a display mode of the direction control being a first display mode, and the first display mode being configured for indicating that a moving mode of the virtual object in the virtual environment is a non-static step mode.

In some embodiments, a client that can provide the virtual environment is installed and run in a terminal device. The client may be a client of any type. However, the disclosure is not limited thereto. The client may be a client that may be downloaded and installed, or may be an embedded program that relies on a host program to run, including but not limited to a mini program. A type of the client is not limited in some embodiments. Based on that the client is the embedded program, where the embedded program is an application program that is developed and completed based on a programming language and that relies on the host program to run, the embedded program may not be downloaded and installed, and may be dynamically loaded in the host program to run. A user may find an embedded program that is used by the user in a manner of searching, scanning, or the like, and the embedded program may be run and used through clicking/tapping and opening. After the embedded program is closed after use, an internal memory of the terminal device is not occupied. This may be convenient. The client may be a client from a first-person perspective, or may be a client from a third-person perspective. The client may display, from the first-person perspective, a virtual environment seen by the user, or may display, from a perspective of a camera, a virtual environment photographed by the camera. The camera is located at a location at a distance behind a virtual object controlled by the user. The client may be a client based on frame synchronization. The control method provided in some embodiments may be applied to the client based on the frame synchronization.

In some embodiments, related information of the client is displayed in a display interface of the terminal device. The related information of the client may be an icon of the client, a name of the client, or other information of the client. The related information of the client is not limited.

When the user expects to run the client, the user selects the related information of the client, and the terminal device receives a trigger operation for the related information of the client, runs the client, and displays a front page of the client. A start control is displayed in a home page of the client. The start control is configured to start a game, start to learn an online course, watch a live stream, start a chat interface with a friend, and the like. The virtual environment picture is displayed in response to the trigger operation for the start control, the direction control is displayed in the virtual environment picture, and the direction control is configured to control the virtual object to move in the virtual environment. The virtual environment is further displayed in the virtual environment picture, and the virtual object, a virtual item, or the like included in the virtual environment is further displayed in the virtual environment picture. Content displayed in the virtual environment picture is not limited. The display mode of the direction control is the first display mode. The first display mode is configured for indicating that the moving mode of the virtual object in the virtual environment is a non-static step mode. For example, the first display mode may indicate that the virtual object is in a running mode or otherwise not in a static step mode.

In some embodiments, different display modes of the direction control refer to different displayed colors of the direction control. In some embodiments, that the display mode of the direction control is the first display mode means that the direction control is displayed in gray. The display mode of the direction control is the first display mode may mean that the direction control is displayed in another color. This is not limited.

In some embodiments, different display modes of the direction control refer to different shapes of the direction control. In some embodiments, that the display mode of the direction control is the first display mode means that the direction control is displayed in a square. The display mode of the direction control is the first display mode may mean that the direction control is displayed in another shape. This is not limited.

In some embodiments, different display modes of the direction control refer to different patterns displayed in an area in which the direction control is located. In some embodiments, that the display mode of the direction control is the first display mode means that a non-static moving pattern, for example, a running pattern or another pattern, is displayed in the area in which the direction control is located. This is not limited.

The foregoing plurality of some embodiments may be combined in any form. For example, the different display modes of the direction control refer to different combination manners including colors of the direction control and patterns displayed in the area in which the direction control is located.

That the user selects the related information of the client may be that the user clicks/taps the related information of the client, may be that the user double-clicks/double-taps the related information of the client, may be that the user selects the related information of the client in a voice manner, or may be that the user selects related information of the client in another manner. This is not limited. A process of the trigger operation for the start control is similar to a process in which the user selects the related information of the client.

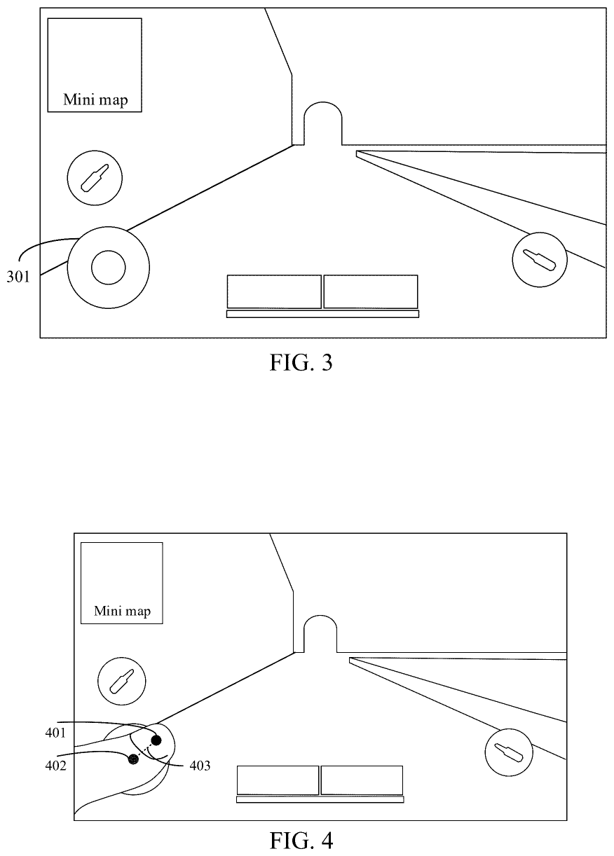

FIG. 3 is a schematic diagram of display of a virtual environment picture according to some embodiments. A direction control 301 is displayed in the virtual environment picture shown in FIG. 3, and the direction control 301 is displayed in gray.

In some embodiments, a virtual object located in a virtual environment may be further displayed in the virtual environment picture, and the virtual object has a virtual item. A shoot control may be further displayed in the virtual environment picture, and the shoot control is configured to emit a virtual resource corresponding to the virtual item. For example, the virtual item is a virtual projectile, and a virtual resource corresponding to the virtual projectile is a virtual bullet. In response to a trigger operation for the shoot control, the virtual projectile is controlled to fire the virtual bullet.

Operation 202: Display the direction control in an adjusted display mode of the direction control in response to a target gesture operation for the direction control, where an operation distance corresponding to the target gesture operation is not greater than a static step range threshold, and the adjusted display mode of the direction control is configured to indicate that the moving mode of the virtual object in the virtual environment is a static step mode.

In some embodiments, types of direction controls are different, target gesture operations for the direction controls are different, and manners of determining operation distances corresponding to the target gesture operations are also different. In the following two cases, the operation distances corresponding to the target gesture operations are determined based on different types of direction controls in response to the target gesture operations for the direction controls.

Case 1: A type of direction control is a fixed direction control, and the target gesture operation for the direction control is a trigger operation for the direction control. A distance between a location corresponding to the trigger operation and a center of the direction control is determined in response to the trigger operation for the direction control. The distance between the location corresponding to the trigger operation and the center of the direction control is determined as the operation distance.

The trigger operation for the direction control may be a click/tap operation for the direction control, may be a long-press operation for the direction control, or may be another operation for the direction control. This is not limited.

In some embodiments, location information of the location corresponding to the trigger operation and location information of the center of the direction control may be first determined before the distance between the location corresponding to the trigger operation and the center of the direction control is determined in response to the trigger operation for the direction control. A process of determining the location information of the location corresponding to the trigger operation includes: determining, as the location information of the location corresponding to the trigger operation in response to the trigger operation for the direction control, the location information that is of the location of the trigger operation and that is in the display interface of the terminal device.

A process of determining the location information of the center of the direction control includes: storing the location information of the center of the direction control in a server, and obtaining, in response to the trigger operation for the direction control, the location information of the center of the direction control through interaction with the server.

In some embodiments, a location information obtaining request is generated in response to the trigger operation for the direction control, and the location information obtaining request is configured for obtaining the location information of the center of the direction control. The location information obtaining request is transmitted to the server. The server receives the location information obtaining request, and transmits the location information of the center of the direction control to the terminal device, so that the terminal device obtains the location information of the center of the direction control.

The location information of the center of the direction control may be two-dimensional location information or three-dimensional location information. The location information of the location corresponding to the trigger operation may be two-dimensional location information or three-dimensional location information. This is not limited. Dimensions of the location information of the center of the direction control and the location information of the location corresponding to the trigger operation are the same.

After the location information of the center of the direction control and the location information of the location corresponding to the trigger operation are obtained, the distance between the location corresponding to the trigger operation and the center of the direction control is determined based on the location information of the center of the direction control and the location information of the location corresponding to the trigger operation. In some embodiments, a Euclidean distance between the location information of the center of the direction control and the location information of the location corresponding to the trigger operation is determined as the distance between the location corresponding to the trigger operation and the center of the direction control.

For example, the location information of the center of the direction control is (X1, Y1, Z1), and the location information of the location corresponding to the trigger operation is (X2, Y2, Z2). It is determined that the distance between the location corresponding to the trigger operation and the center of the direction control is \sqrt{(X1−X2)²+(Y1−Y2)²+(Z1−Z2)²}.

In some embodiments, the distance between the location corresponding to the trigger operation and the center of the direction control may be determined in the following manner: The terminal device includes a distance determining module, and invokes, in response to the trigger operation for the direction control, the distance determining module, to determine the distance between the location corresponding to the trigger operation and the center of the direction control.

FIG. 4 is a schematic diagram of display of another virtual environment picture according to some embodiments. In the virtual environment picture shown in FIG. 4, 401 is a location corresponding to a trigger operation, 402 is a center of a direction control, and 403 is a distance between the location corresponding to the trigger operation and the center of the direction control.

A characteristic of a fixed direction control is fully considered, and a direction of a hand relative to the direction control is a moving direction of a virtual object. The center of the direction control is used as a clear reference, and the distance between the location corresponding to the trigger operation and the center of the direction control is determined as an operation distance, so that the operation distance can accurately reflect a value of the moving distance of the virtual object. Accuracy of the operation distance may be improved.

The distance between the location corresponding to the trigger operation and the center of the direction control may be determined in another manner. This is not limited.

Case 2: A type of the direction control is a follower direction control, and a target gesture operation for the direction control is a continuous gesture operation that is with sliding after triggering and that is for the direction control; a sliding operation is performed when a finger is not raised after the direction control is triggered. A distance between the location corresponding to the trigger operation and a location of the sliding operation is determined in response to the continuous gesture operation that is with sliding after triggering and that is for a direction control. The distance between the location corresponding to the trigger operation and the location of the sliding operation is used as the operation distance.

The trigger operation for the direction control may be a click/tap operation for the direction control, may be a long-press operation for the direction control, or may be another operation for the direction control. This is not limited.

In some embodiments, location information of the location corresponding to the trigger operation and location information of the location of the sliding operation may be first obtained before the distance between the location corresponding to the trigger operation and the location of the sliding operation is determined in response to the continuous gesture operation that is with sliding after triggering and that is for the direction control. A process of obtaining location information of the location corresponding to the trigger operation and a process of obtaining location information of the location of the sliding operation are both similar to a process of obtaining the location information of the location corresponding to the trigger operation in Case 1.

A process of determining the distance between the location corresponding to the trigger operation and the location of the sliding operation based on the location information of the location corresponding to the trigger operation and the location information of the sliding operation is similar to a process of determining the distance between the location corresponding to the trigger operation and the center of the direction control based on the location information of the location corresponding to the trigger operation and the location information of the center of the direction control in Case 1.

In some embodiments, a distance determining module may be further invoked, in response to the continuous gesture operation that is with sliding after triggering and that is for the direction control, to determine the distance between the location corresponding to the trigger operation and the location of the sliding operation.

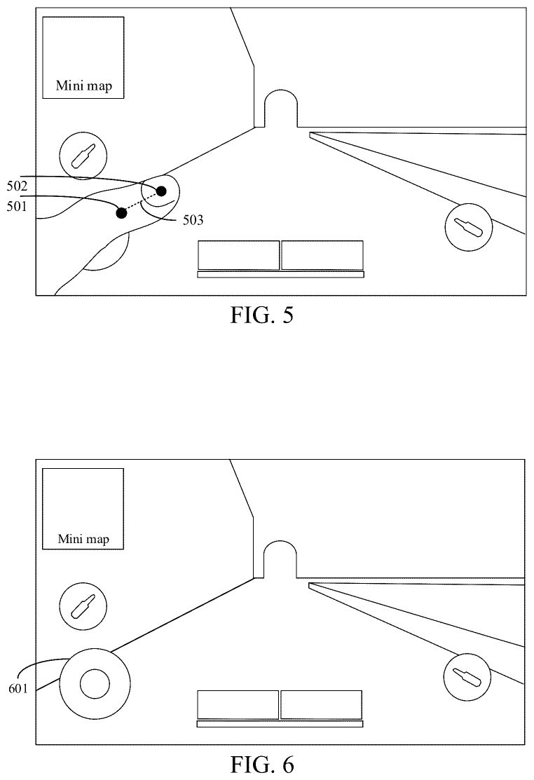

For example, FIG. 5 is a schematic diagram of display of another virtual environment picture according to some embodiments. In the virtual environment picture shown in FIG. 5, 501 is a location corresponding to a trigger operation, 502 is a current location of a sliding operation, and 503 is a distance between the location corresponding to the trigger operation and the location of the sliding operation.

A characteristic of a follower direction control is fully considered, a location pressed by a finger is used as a center, and a sliding direction of the finger is a moving direction of a virtual object. The location corresponding to the trigger operation is used as a clear reference, and the distance between the location corresponding to the trigger operation and the location of the sliding operation is determined as an operation distance, so that the operation distance can accurately reflect a value of the moving distance of the virtual object. Therefore, accuracy of the operation distance may be improved.

In some embodiments, an adjusted display mode of the direction control is determined based on the operation distance. Different operation distances indicate different adjusted display modes of the direction control. A user can learn of a range of a current operation distance by viewing a display mode of the direction control.

The adjusted display mode of the direction control is determined based on the operation distance based on that the operation distance is not greater than a static step range threshold. The direction control is displayed in the adjusted display mode of the direction control. The adjusted display mode of the direction control is configured for indicating that a moving mode of the virtual object in a virtual environment is a static step mode.

The static step range threshold may be set based on experience or adjusted based on an implementation environment. This is not limited. For example, the static step range threshold is 30 pixels (px).

In some embodiments, when the operation distance is not greater than a distance threshold, the adjusted display mode of the direction control is a second display mode; the distance threshold is less than the static step range threshold, and the second display mode indicates that the moving mode of the virtual object in the virtual environment is the static step mode. When the operation distance is greater than the distance threshold and less than the static step range threshold, the adjusted display mode is a fourth display mode that serves as a transition between the second display mode and a third display mode. When the operation distance equals the static step range threshold, the adjusted display mode is the third display mode, which indicates that the static step mode is about to change.

In some embodiments, after the operation distance is determined, selecting the adjusted display mode of the direction control based on the operation distance (where the operation distance is not greater than the static step range threshold) includes the following three cases.

Case 1: The second display mode is selected as the adjusted display mode of the direction control based on that the operation distance is not greater than the distance threshold.

The distance threshold may be less than the static step range threshold. The distance threshold may be set based on experience or adjusted based on an implementation environment. However, the disclosure is not limited thereto. For example, the distance threshold is 12 pixels. The second display mode is configured for indicating that the moving mode of the virtual object in the virtual environment is still the static step mode.

The second display mode is any display mode different from the first display mode. For example, the second display mode may display the direction control in yellow. FIG. 6 illustrates a virtual environment picture in which a direction control 601 is displayed in yellow (not shown in FIG. 6).

For example, if the distance threshold is 12 pixels and the operation distance is 10 pixels, the display mode of the direction control is adjusted from the first display mode to the second display mode (e.g., from gray to yellow).

The foregoing example uses different colors to represent different display modes. In some embodiments, different display modes refer to different shapes of the direction control; adjusting from the first to the second display mode then corresponds to changing from a first shape to a second shape. In other embodiments, different display modes refer to different patterns displayed in the area in which the direction control is located; adjusting from the first to the second display mode corresponds to changing from a first pattern to a second pattern. Display modes may also be defined by combinations of colors and patterns; adjusting from the first to the second display mode then changes both the color and the pattern accordingly. The specific method for making this adjustment is not limited.

Case 2: The third display mode is selected as the adjusted display mode of the direction control based on that the operation distance being equal to a static step range threshold.

The third display mode indicates that the moving mode of the virtual object is the static step mode but is about to change. Displaying the direction control in the third display mode prompts the user that the operation distance has reached the static step range threshold; if the operation distance increases further, the static step mode will be exited. The third display mode is different from both the first and second display modes (e.g., the direction control is displayed in red).

For example, if the static step range threshold is 30 pixels and the operation distance is 30 pixels, the display mode of the direction control is adjusted from the first display mode to the third display mode (e.g., from gray to red).

The foregoing example uses colors to represent display modes. In some embodiments, different display modes refer to different shapes of the direction control; adjusting to the third display mode corresponds to changing to a third shape. In other embodiments, different display modes refer to different patterns displayed in the area in which the direction control is located; adjusting to the third display mode corresponds to changing to a third pattern. Display modes may also be defined by combinations of colors and patterns; adjusting to the third display mode then changes both the color and the pattern accordingly. The specific method for making this adjustment is not limited.

Case 3: The fourth display mode is selected as the adjusted display mode of the direction control when the operation distance is greater than the distance threshold and less than the static step range threshold.

The fourth display mode is different from the first, second, and third display modes and varies with the operation distance. As the target gesture operation continues and the operation distance changes, the fourth display mode changes accordingly, enabling dynamic updates. When the operation distance is closer to the static step range threshold, the fourth display mode is closer to the third display mode; when the operation distance is closer to the distance threshold, it is closer to the second display mode.

In some embodiments, a display mode corresponding to the operation distance is selected as the fourth display mode when the operation distance is greater than the distance threshold and less than the static step range threshold. A terminal device may store a correspondence between each distance in this range and a display mode. For example, Table 1 shows an exemplary correspondence.

TABLE 1

| Distance | Display mode |
|---|---|
| 13 | Color 1 |
| 14 | Color 2 |
| 15 | Color 3 |
| 16 | Color 4 |
| . . . | . . . |
| 29 | Color N |

It follows from Table 1 that when the distance is 13, the corresponding display mode is Color 1; when the distance is 14, the display mode is Color 2; and so on. For example, if the operation distance determined in operation 202 is 14, Color 2 is selected as the fourth display mode based on Table 1, and the direction control is adjusted from gray to Color 2.

Combining the three cases: consider a target gesture operation whose operation distance gradually increases. Initially, the operation distance is not greater than the distance threshold and the direction control is displayed in the second display mode. When the operation distance becomes greater than the distance threshold and less than the static step range threshold, the direction control is displayed in the fourth display mode, initially close to the second display mode. As the operation distance increases, the fourth display mode becomes less similar to the second display mode and closer to the third display mode. When the operation distance equals the static step range threshold, the direction control is displayed in the third display mode. This yields a natural, gradual transition from the second display mode through the fourth display mode to the third display mode.

In some embodiments, the direction control changes to yellow when the operation distance is not greater than the distance threshold; to red when the operation distance equals the static step range threshold; and to a color corresponding to the operation distance when the operation distance is greater than the distance threshold and less than the static step range threshold. The corresponding color may be a gradient from yellow to red: the closer to the static step range threshold, the closer to red; the closer to the distance threshold, the closer to yellow.

In some embodiments, the second display mode is a first color, the third display mode is a second color, and the fourth display mode is a gradient color between them. When the operation distance is greater than the distance threshold and less than the static step range threshold, if the operation distance is closer to the distance threshold, the color corresponding to the operation distance is closer to the first color; if it is closer to the static step range threshold, the color is closer to the second color.

In some embodiments, the second display mode is a first shape, the third display mode is a second shape, and the fourth display mode is a gradient shape between them. When the operation distance is greater than the distance threshold and less than the static step range threshold, if the operation distance is closer to the distance threshold, the shape corresponding to the operation distance is closer to the first shape; if it is closer to the static step range threshold, the shape is closer to the second shape.

In some embodiments, the second display mode displays a first pattern in the area in which the direction control is located, the third display mode displays a second pattern, and the fourth display mode displays a gradient pattern between them. When the operation distance is greater than the distance threshold and less than the static step range threshold, if the operation distance is closer to the distance threshold, the pattern corresponding to the operation distance is closer to the first pattern; if it is closer to the static step range threshold, the pattern is closer to the second pattern.

The foregoing three cases may be combined in any form. The specific combination manner is not limited

In some embodiments, a static step indicator may be displayed in the virtual environment picture in response to the target gesture operation for the direction control, indicating that the moving mode of the virtual object is the static step mode. The operation distance corresponding to the target gesture operation is not greater than the static step range threshold.

When the operation distance is not greater than the static step range threshold, the display mode of the direction control is adjusted and the static step indicator is displayed in the virtual environment picture. Because a user's finger may completely cover the direction control when triggering it, adjusting only the display mode of the direction control may not allow the user to perceive the change or the moving mode. Displaying the static step indicator in addition to adjusting the display mode enables the user to perceive the moving mode even when the finger covers the direction control.

In some embodiments, the display mode of the static step indicator is the same as the adjusted display mode of the direction control. For example, if the adjusted display mode displays the direction control in yellow (or red), the static step indicator is displayed in yellow (or red). This maintains a consistent visual presentation, improves the overall interface effect, and helps the user quickly determine the current moving mode, thereby avoiding confusion and interference with operation

In some embodiments, when the operation distance is not greater than the static step range threshold, a display location of the static step indicator may be determined before the indicator is displayed. The method of determining the display location is not limited

In some embodiments, the display location of the static step indicator is determined as follows. First, determine the display location of the static step indicator based on the target gesture operation for the direction control when the operation distance is not greater than the static step range threshold; then display the static step indicator at the determined location in the virtual environment picture, ensuring that the display location is related to the target gesture operation. Because the user's visual focus may be near the target gesture operation, determining the display location based on that operation helps keep the indicator within the user's field of view and ensures effective display

If target gesture operations for the direction control differ, the method of determining the display location of the static step indicator also differs. The display location may be determined as follows in two representative cases.

First case: the direction control is a fixed direction control, and the target gesture operation is a trigger operation. The display location of the static step indicator is determined based on the trigger operation.

In some embodiments, a first ray using the center of the direction control as a starting point and passing through the location corresponding to the trigger operation is determined. A first point on the first ray is selected as the display location of the static step indicator, where the distance between the first point and a second point meets a distance requirement, the first point is not located at the direction control, and the second point is an intersection point of the first ray and the direction control.

Meeting the distance requirement means that the distance between the first point and the second point equals a target distance, which may be set based on experience or adjusted during implementation. For example, the target distance may be 3 pixels.

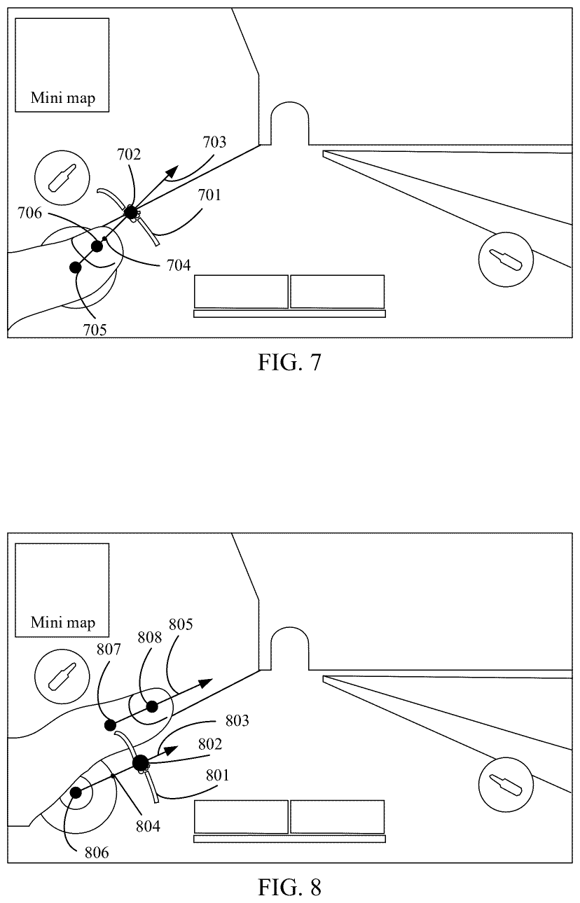

For example, FIG. 7 illustrates a virtual environment picture in which a static step indicator 701 is displayed at a first point 702 on a first ray 703, with the distance between the first point 702 and a second point 704 meeting the distance requirement. The first ray 703 uses the center 705 of a direction control as a starting point and passes through a location 706 corresponding to a trigger operation.

Because a user's visual focus is near the trigger location when performing the trigger operation, the static step indicator is displayed along the extension from the center of the direction control to the trigger location, i.e., in the direction of the user's finger. Selecting the first point to satisfy the distance requirement prevents the finger from covering the indicator and keeps the indicator within the user's field of view, enabling rapid perception and effective display.

Second case: the direction control is a follower direction control, and the target gesture operation is a continuous gesture operation with sliding after triggering; the operation includes the trigger operation and a sliding operation. The display location of the static step indicator is determined based on this continuous gesture operation.

In some embodiments, a second ray using the location corresponding to the trigger operation as a starting point and passing through the location of the sliding operation is determined. A third ray parallel to the second ray and using the center of the direction control as a starting point is then determined. A third point on the third ray is selected as the display location of the static step indicator, where the distance between the third point and a fourth point meets a distance requirement, the third point is not located at the direction control, and the fourth point is an intersection point of the third ray and the direction control.

For example, FIG. 8 illustrates a virtual environment picture in which a static step indicator 801 is displayed at a third point 802 on a third ray 803, with the distance between the third point 802 and a fourth point 804 meeting the distance requirement. The third ray 803 is parallel to a second ray 805 and uses the center 806 of a direction control as a starting point; the second ray 805 uses a location 807 corresponding to a trigger operation as a starting point and passes through a location 808 of a sliding operation.

The static step indicator is displayed along a direction that uses the center of the direction control as the starting point and is parallel to the direction from the trigger location to the sliding location. This allows the user to infer the sliding direction angle using the direction control as a reference. Because the user's visual focus is near the sliding location when performing the operations, placing the indicator near the sliding location helps keep it within the user's field of view and ensures effective display.

In some embodiments, after the direction control is displayed in an adjusted display mode, subsequent operations may further adjust the display mode. Specifically, when the direction control is a fixed direction control and the target gesture operation is a trigger operation, upon receiving a subsequent sliding operation, determine the distance between the sliding location and the center of the direction control; display the direction control in a first display mode if this distance is greater than the static step range threshold (e.g., display the direction control in gray), thereby indicating a non-static step mode.

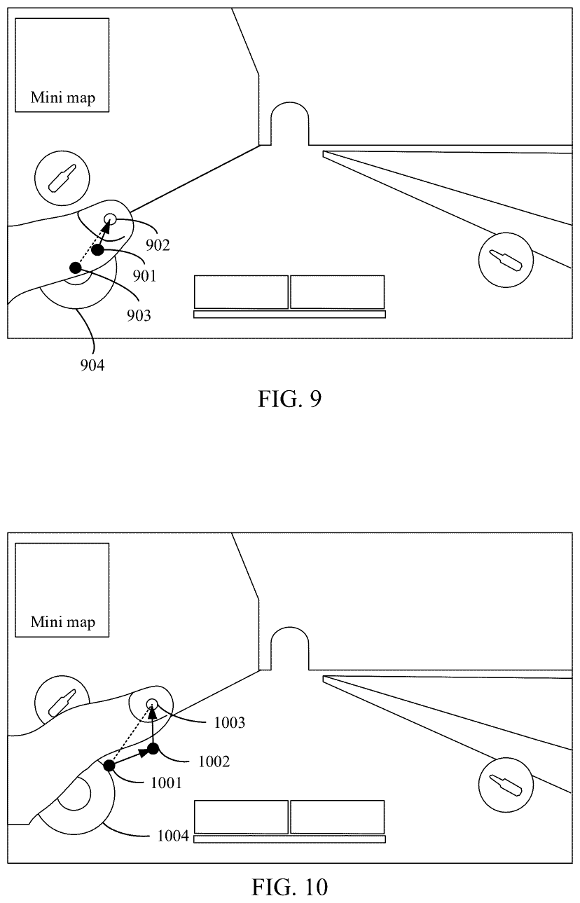

For example, FIG. 9 illustrates a virtual environment picture in which a trigger operation occurs at location 901, followed by a sliding operation at location 902. If the distance between the sliding location and the center 903 of the direction control exceeds the static step range threshold, the direction control 904 is displayed in gray (the first display mode).

When a user performs a sliding operation after triggering a fixed direction control, checking whether the distance between the sliding location and the center of the direction control exceeds the static step range threshold enables rapid determination of whether the static step mode has been exited. The direction control is then displayed in the first display mode, ensuring that the display mode matches the moving mode of the virtual object and improving accuracy.

In some embodiments, display of the static step indicator is canceled when the distance between the sliding location and the center of the direction control is greater than the static step range threshold.

When the direction control is a follower direction control and the target gesture operation is a continuous gesture operation with sliding after triggering (including the trigger operation and a sliding operation), a subsequent secondary sliding operation may be received. Determine the distance between the location of the secondary sliding operation and the location corresponding to the trigger operation. Display the direction control in the first display mode if this distance is greater than the static step range threshold (e.g., display the direction control in gray).

In some embodiments, display of the static step indicator is canceled when the distance between the location of the secondary sliding operation and the location corresponding to the trigger operation is greater than the static step range threshold.

For example, FIG. 10 illustrates a virtual environment picture in which a trigger operation occurs at location 1001, an initial sliding operation occurs at location 1002, and a secondary sliding operation occurs at location 1003. If the distance between the secondary sliding location 1003 and the trigger location 1001 exceeds the static step range threshold, the direction control 1004 is displayed in gray (the first display mode).

When a user performs a secondary sliding operation after triggering a follower direction control, checking whether the distance between the secondary sliding location and the trigger location exceeds the static step range threshold enables rapid determination of whether the static step mode has been exited. The direction control is then displayed in the first display mode, ensuring consistency between the display mode and the moving mode and improving accuracy.

In the foregoing method, when the direction control is triggered and the operation distance corresponding to a target gesture operation is not greater than the static step range threshold, an adjusted display mode is determined and applied. The user can thus determine whether the moving mode is the static step mode based on the adjusted display mode, without shaking the virtual environment. This increases the accuracy with which the moving mode of the virtual object is determined and improves control.

Because the adjusted display mode of the direction control is determined based on the operation distance, the user can infer both whether the moving mode is the static step mode and the range of the current operation distance. This provides intuition about changes in the operation distance and increases the amount of displayed information. The user may then select a next operation based on the current operation distance to improve control of the virtual object.

Different ranges of the operation distance correspond to the second, fourth, and third display modes. The second display mode indicates the static step mode; the third display mode indicates the static step mode is about to change; and the fourth display mode provides a transition between the second and third display modes. This progressive arrangement allows the user to understand the range of the operation distance from the display mode, and transitions among the modes occur naturally as the operation distance changes.

For the fourth display mode, a fixed display is not used; instead, the fourth display mode varies with the operation distance. When the operation distance is closer to the distance threshold, the fourth display mode is closer to the second display mode; when it is closer to the static step range threshold, it is closer to the third display mode. Thus, as the operation distance changes, the fourth display mode dynamically updates, improving the display effect.

Some embodiments provide multiple methods for classifying different display modes. For example, different display modes of the direction control may correspond to different colors, different shapes, or different patterns displayed in the area in which the direction control is located. For any such classification, the methods in some embodiments may be used to adaptively adjust the display mode of the direction control so that it is displayed based on an adjusted display mode, thereby improving flexibility.

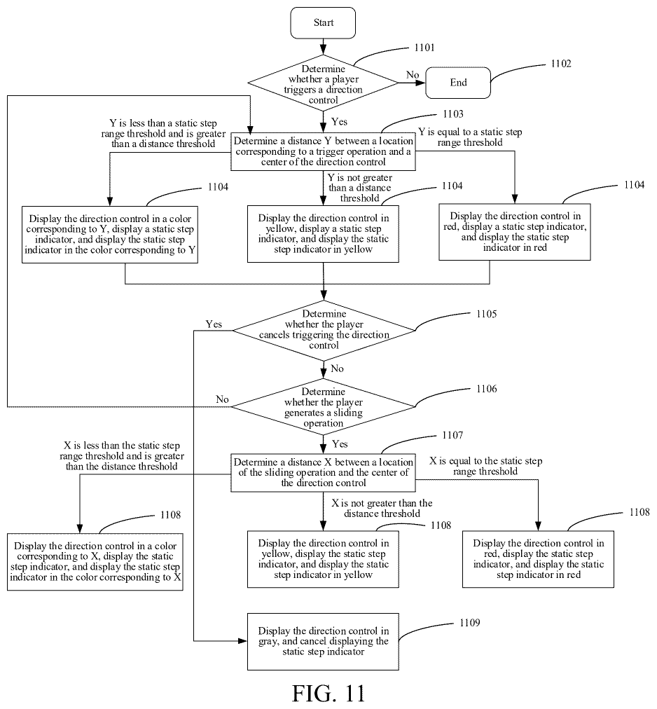

FIG. 11 is a flowchart of a control method according to some embodiments when the direction control is a fixed direction control. As shown in FIG. 11, the method includes operations 1101 to 1109.

Operation 1101: Determine whether a player triggers the direction control. Based on that the player does not trigger the direction control, perform operation 1102; or based on that the player triggers the direction control, perform operation 1103.

Operation 1102: End a procedure.

Operation 1103: Determine a distance Y between a location corresponding to a trigger operation and a center of the direction control.

Operation 1104: Based on that Y is equal to a static step range threshold, display the direction control in red, display a static step indicator, and display the static step indicator in red. Based on that Y is not greater than a distance threshold, display the direction control in yellow, display a static step indicator, and display the static step indicator in yellow. Based on that Y is less than a static step range threshold and is greater than a distance threshold, display the direction control in a color corresponding to Y, display a static step indicator, and display the static step indicator in the color corresponding to Y.

When Y is less than the static step range threshold and greater than the distance threshold, the color corresponding to Y is a gradient between yellow and red. When Y is greater than the static step range threshold, do not change the direction control and do not display a static step indicator.

Operation 1105: Determine whether the player cancels triggering the direction control. Based on that the player does not cancel triggering the direction control, perform operation 1106; or based on that the player cancels triggering the direction control, perform operation 1109.

Operation 1106: Determine whether the player generates a sliding operation. Based on that the player generates the sliding operation, perform operation 1107; or based on that the player does not generate the sliding operation, perform operation 1103.

Operation 1107: Determine a distance X between a location of the sliding operation and the center of the direction control.

Operation 1108: Based on that X is equal to the static step range threshold, display the direction control in red, display the static step indicator, and display the static step indicator in red. Based on that X is not greater than the distance threshold, display the direction control in yellow, display the static step indicator, and display the static step indicator in yellow. Based on that X is less than the static step range threshold and is greater than the distance threshold, display the direction control in a color corresponding to X, display the static step indicator, and display the static step indicator in the color corresponding to X.

When X is less than the static step range threshold and greater than the distance threshold, the color corresponding to X is a gradient between yellow and red. When X is greater than the static step range threshold, do not change the direction control and do not display a static step indicator.

Operation 1109: Display the direction control in gray, and cancel displaying the static step indicator.

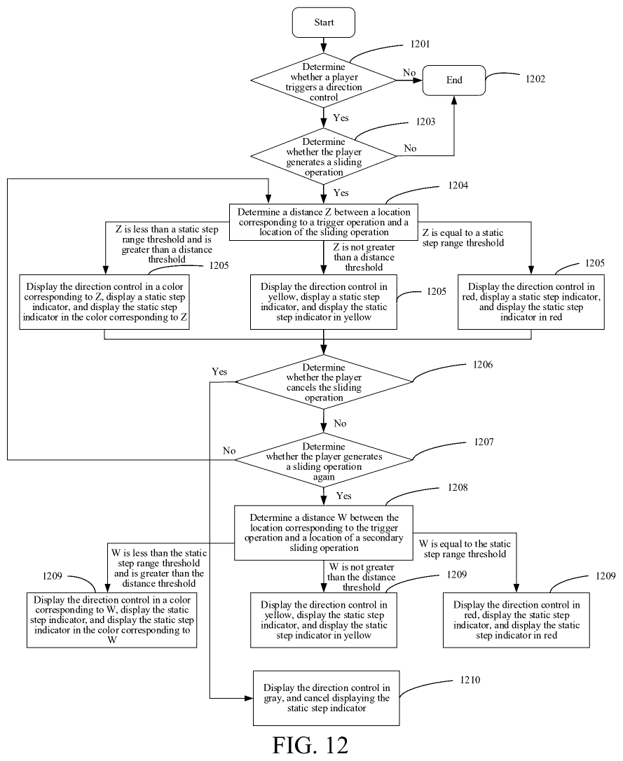

FIG. 12 is a flowchart of a control method according to some embodiments when the direction control is a follower direction control. As shown in FIG. 12, the method includes operations 1201 to 1210.

Operation 1201: Determine whether a player triggers the direction control. Based on that the player does not trigger the direction control, perform operation 1202; or based on that the player triggers the direction control, perform operation 1203.

Operation 1202: End a procedure.

Operation 1203: Determine whether the player generates a sliding operation.

Based on that the player generates the sliding operation, perform operation 1204; or based on that the player does not generate the sliding operation, perform operation 1202.

Operation 1204: Determine a distance Z between a location corresponding to a trigger operation and a location of the sliding operation.

Operation 1205: Based on that Z is equal to a static step range threshold, display the direction control in red, display a static step indicator, and display the static step indicator in red. Based on that Z is not greater than a distance threshold, display the direction control in yellow, display a static step indicator, and display the static step indicator in yellow. Based on that Z is less than a static step range threshold and is greater than a distance threshold, display the direction control in a color corresponding to Z, display a static step indicator, and display the static step indicator in the color corresponding to Z.

When Z is less than the static step range threshold and greater than the distance threshold, the color corresponding to Z is a gradient between yellow and red. When Z is greater than the static step range threshold, do not change the direction control and do not display a static step indicator.

Operation 1206: Determine whether the player cancels the sliding operation. Based on that the player does not cancel the sliding operation, perform operation 1207; or based on that the player cancels the sliding operation, perform operation 1210.

Operation 1207: Determine whether the player generates a sliding operation again.

Operation 1208: Based on that the player generates the sliding operation again, determine a distance W between the location corresponding to the trigger operation and a location of a secondary sliding operation.

If the player does not generate the sliding operation again, perform operation 1204.

Operation 1209: Based on that W is equal to the static step range threshold, display the direction control in red, display the static step indicator, and display the static step indicator in red. Based on that W is not greater than the distance threshold, display the direction control in yellow, display the static step indicator, and display the static step indicator in yellow. Based on that W is less than the static step range threshold and is greater than the distance threshold, display the direction control in a color corresponding to W, display the static step indicator, and display the static step indicator in the color corresponding to W.

When W is less than the static step range threshold and greater than the distance threshold, the color corresponding to W is a gradient between yellow and red. When W is greater than the static step range threshold, do not change the direction control and do not display a static step indicator.

Operation 1210: Display the direction control in gray, and cancel display of the static step indicator.

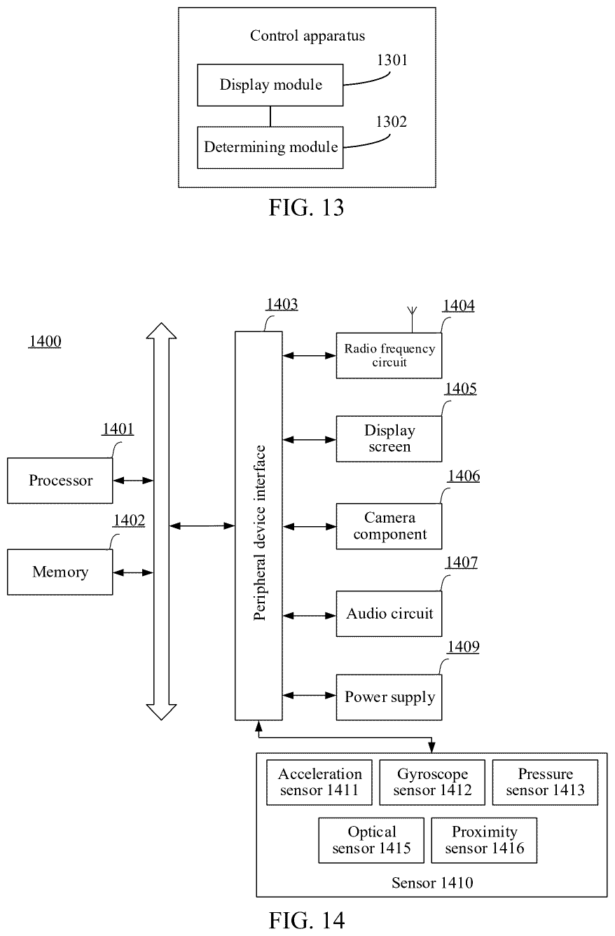

FIG. 13 is a schematic diagram of a structure of a control apparatus according to some embodiments. As shown in FIG. 13, the apparatus includes:
a display module 1301, configured to display a virtual environment picture, a direction control being displayed in the virtual environment picture, the direction control being configured to control a virtual object to move in a virtual environment, a display mode of the direction control being a first display mode, and the first display mode being configured for indicating that a moving mode of the virtual object in the virtual environment is a non-static step mode; and
the display module 1301 being configured to display the direction control in an adjusted display mode of the direction control in response to a target gesture operation for the direction control, an operation distance corresponding to the target gesture operation being not greater than a static step range threshold, and the adjusted display mode of the direction control being configured for indicating that the moving mode of the virtual object in the virtual environment is a static step mode.

In some embodiments, the adjusted display mode of the direction control is determined based on the operation distance.

In some embodiments, in a case that the operation distance is not greater than a distance threshold, the adjusted display mode of the direction control is a second display mode, the distance threshold is less than the static step range threshold, and the second display mode is configured for indicating that the moving mode of the virtual object in the virtual environment is a static step mode.

In a case that the operation distance is greater than a distance threshold and is less than the static step range threshold, the adjusted display mode of the direction control is a fourth display mode, and the fourth display mode is a transition display mode between the second display mode and a third display mode.

In a case that the operation distance is equal to the static step range threshold, the adjusted display mode of the direction control is the third display mode, and the third display mode is configured for indicating that the moving mode of the virtual object in the virtual environment is the static step mode but is about to change.

In some embodiments, the apparatus further includes:
a determining module 1302, configured to: determine the second display mode as the adjusted display mode of the direction control when the operation distance is not greater than the distance threshold; determine the third display mode as the adjusted display mode when the operation distance equals the static step range threshold; and determine the fourth display mode as the adjusted display mode when the operation distance is greater than the distance threshold and less than the static step range threshold, where the fourth display mode corresponds to the operation distance. If the operation distance is closer to the distance threshold, the fourth display mode is closer to the second display mode; if the operation distance is closer to the static step range threshold, the fourth display mode is closer to the third display mode.

In some embodiments, the second display mode is a first color, the third display mode is a second color, and the fourth display mode is a gradient color between them. When the operation distance is greater than the distance threshold and less than the static step range threshold, if the operation distance is closer to the distance threshold, the color corresponding to the operation distance is closer to the first color; if the operation distance is closer to the static step range threshold, the color is closer to the second color.

In some embodiments, the second display mode is a first shape, the third display mode is a second shape, and the fourth display mode is a gradient shape between them. When the operation distance is greater than the distance threshold and less than the static step range threshold, if the operation distance is closer to the distance threshold, the corresponding shape is closer to the first shape; if the operation distance is closer to the static step range threshold, the corresponding shape is closer to the second shape.

In some embodiments, the second display mode displays a first pattern in the area in which the direction control is located, the third display mode displays a second pattern, and the fourth display mode displays a gradient pattern between them. When the operation distance is greater than the distance threshold and less than the static step range threshold, if the operation distance is closer to the distance threshold, the corresponding pattern is closer to the first pattern; if the operation distance is closer to the static step range threshold, the corresponding pattern is closer to the second pattern.

In some embodiments, the display module 1301 is further configured to display a static step indicator in a virtual environment picture in response to the target gesture operation for the direction control. The static step indicator is configured for indicating that the moving mode of the virtual object in the virtual environment is the static step mode. An operation distance corresponding to the target gesture operation is not greater than the static step range threshold.

In some embodiments, a display mode of the static step indicator is the same as the adjusted display mode of the direction control.

In some embodiments, the apparatus further includes:
the determining module 1302, configured to determine a display location of the static step indicator based on the target gesture operation for the direction control based on that the operation distance is not greater than the static step range threshold; and
the display module 1301 being configured to display the static step indicator at the display location of the static step indicator in the virtual environment picture.

In some embodiments, the determining module 1302 is configured to determine, when the direction control is a fixed direction control and the target gesture operation is a trigger operation, a first ray that uses a center of the direction control as a starting point and passes through a location corresponding to the trigger operation; and to determine a first point on the first ray as the display location of the static step indicator, where the distance between the first point and a second point meets a distance requirement, the first point is not located at the direction control, and the second point is an intersection of the first ray and the direction control.

In some embodiments, the determining module 1302 is configured to determine, when the direction control is a follower direction control and the target gesture operation is a continuous gesture operation with sliding after triggering, a second ray that uses the location corresponding to the trigger operation as a starting point and passes through a location of a sliding operation; determine a third ray that is parallel to the second ray and uses the center of the direction control as a starting point; and determine a third point on the third ray as the display location of the static step indicator, where the distance between the third point and a fourth point meets a distance requirement, the third point is not located at the direction control, and the fourth point is an intersection of the third ray and the direction control.

In some embodiments, the type of the direction control is the fixed direction control, and the target gesture operation is the trigger operation.

The determining module 1302 is configured to determine a distance between the location corresponding to the trigger operation and the center of the direction control in response to the trigger operation, and to determine this distance as the operation distance.

In some embodiments, the type of the direction control is the follower direction control, and the target gesture operation is the continuous gesture operation with sliding after triggering.

The determining module 1302 is configured to determine a distance between the location corresponding to the trigger operation and the location of the sliding operation in response to the continuous gesture operation with sliding after triggering, and to determine this distance as the operation distance.

In some embodiments, the type of the direction control is the fixed direction control, and the target gesture operation is the trigger operation.

The determining module 1302 is further configured to determine, in response to receiving, after the trigger operation, a sliding operation for the direction control, a distance between the location of the sliding operation and the center of the direction control.

The display module 1301 is further configured to adjust the display mode of the direction control to the first display mode when the distance between the location of the sliding operation and the center of the direction control is greater than the static step range threshold.

In some embodiments, the type of the direction control is the follower direction control, and the target gesture operation is the continuous gesture operation with sliding after triggering.

The determining module 1302 is further configured to determine, in response to receiving, after the sliding operation, a secondary sliding operation for the direction control, a distance between a location of the secondary sliding operation and the location corresponding to the trigger operation.

The display module 1301 is further configured to adjust the display mode of the direction control to the first display mode when the distance between the location of the secondary sliding operation and the location corresponding to the trigger operation is greater than the static step range threshold.

In the foregoing apparatus, when the direction control is triggered and the operation distance corresponding to the target gesture operation is not greater than the static step range threshold, an adjusted display mode of the direction control is determined and applied. Based on the adjusted display mode, the user can determine whether the moving mode of the virtual object is the static step mode without shaking the virtual environment, thereby improving the accuracy with which the moving mode is determined and enhancing control of the virtual object.

When implementing the foregoing functions, the division into function modules is illustrative. In practical applications, the functions may be allocated to and completed by different modules based on requirements. An internal device structure may be divided into different modules to complete all or part of the functions described above. The apparatus and method described in some embodiments belong to the same concept. For implementation, refer to the foregoing method embodiments.

FIG. 14 shows a block diagram of a structure of a terminal device 1400 according to some embodiments. The terminal device 1400 may be any electronic device product that may perform human-machine interaction with a user in one or more manners such as a keyboard, a touch pad, a remote control, voice interaction, or a handwriting device, for example, a personal computer (PC), a mobile phone, a smartphone, a personal digital assistant (PDA), a wearable device, a pocket PC (PPC), a tablet computer, a smart on board unit, a smart television, a smart speaker, a smart watch. The terminal device 1400 includes a processor 1401 and a memory 1402.

The processor 1401 may include one or more processing cores, for example, a 4-core processor and an 8-core processor. The processor 1401 may be implemented in at least one hardware form of a digital signal processor (DSP), a field-programmable gate array (FPGA), and a programmable logic array (PLA). In some embodiments, the processor 1401 may further include an artificial intelligence (AI) processor. The AI processor is configured to process computing operations related to machine learning.

The memory 1402 may include one or more computer-readable storage media. The computer-readable storage medium may be non-transitory. In some embodiments, the non-transitory computer-readable storage medium in the memory 1402 is configured to store at least one instruction, and the at least one instruction is configured to be executed by the processor 1401 to implement the control method provided in some method embodiments.

In some embodiments, the terminal device 1400 may further include: a peripheral device interface 1403 and at least one peripheral device. The processor 1401, the memory 1402, and the peripheral device interface 1403 may be connected through a bus or a signal cable. Each peripheral device may be connected to the peripheral device interface 1403 through a bus, a signal cable, or a circuit board. The peripheral device includes at least one of a radio frequency circuit 1404, a display screen 1405, a camera component 1406, an audio circuit 1407, and a power supply 1409.

The peripheral device interface 1403 may be configured to connect, to the processor 1401 and the memory 1402, the at least one peripheral device related to input/output (I/O). In some embodiments, the processor 1401, the memory 1402, and the peripheral device interface 1403 are integrated on the same chip or circuit board. In some embodiments, any one or two of the processor 1401, the memory 1402, and the peripheral device interface 1403 may be implemented on a single chip or circuit board. This is not limited in some embodiments.

The radio frequency circuit 1404 is configured to receive and transmit a radio frequency (RF) signal, which is also referred to as an electromagnetic signal. The radio frequency circuit 1404 communicates with a communication network and another communication device through the electromagnetic signal. The radio frequency circuit 1404 converts an electric signal into an electromagnetic signal for transmission, or converts a received electromagnetic signal into an electric signal.

The display screen 1405 is configured to display a user interface (UI). The UI may include a graph, text, an icon, a video, and any combination thereof. When the display screen 1405 is a touch display screen, the display screen 1405 further has a capability of obtaining a touch signal on or above a surface of the display screen 1405. The touch signal may be input to the processor 1401 as a control signal for processing. The display screen 1405 may be further configured to provide a virtual button and/or a virtual keyboard, which is also referred to as a soft button and/or a soft keyboard.

The camera component 1406 is configured to obtain images or videos. In some embodiments, the camera component 1406 includes a front-facing camera and a rear-facing camera. In some embodiments, there are at least two rear-facing cameras, which are respectively any of a main camera, a depth-of-field camera, a wide-angle camera, and a telephoto camera, to achieve background blur through fusion of the main camera and the depth-of-field camera, panoramic photographing and virtual reality (VR) photographing through fusion of the main camera and the wide-angle camera, or other fusion photographing functions.

The audio circuit 1407 may include a microphone and a speaker. The microphone is configured to obtain sound waves of a user and an environment, and convert the sound waves into an electrical signal to be input to the processor 1401 for processing, or be input to the radio frequency circuit 1404 for implementing voice communication. The speaker may be a film speaker, or may be a piezoelectric ceramic speaker. In some embodiments, the audio circuit 1407 may further include an earphone jack.

The power supply 1409 is configured to supply power to components in the terminal device 1400. The power supply 1409 may be an alternating current, a direct current, a primary battery, or a rechargeable battery. When the power supply 1409 includes the rechargeable battery, and the rechargeable battery may be a wired rechargeable battery or a wireless rechargeable battery.

In some embodiments, the terminal device 1400 further includes one or more sensors 1410. The one or more sensors 1410 include but are not limited to an acceleration sensor 1411, a gyroscope sensor 1412, a pressure sensor 1413, an optical sensor 1415, and a proximity sensor 1416.

A person skilled in the art may understand that the structure shown in FIG. 14 constitutes no limitation on the terminal device 1400, and the terminal device 1400 may include more or fewer components than those shown in the figure, some components may be combined, or a different component deployment may be used.

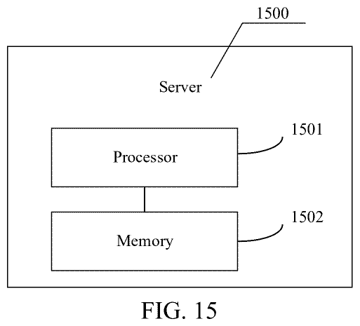

FIG. 15 is a schematic diagram of a structure of a server according to some embodiments. The server 1500 may vary due to different configurations or performance, and may include one or more processors (Central Processing Units, CPUs) 1501 and one or more memories 1502. The one or more memories 1502 store at least one piece of program code, and the program code is loaded and executed by the one or more processors 1501 to implement the control method provided in some embodiments. The server 1500 may further have components such as a wired or wireless network interface, a keyboard, and an input/output interface to support input and output. The server 1500 may further include another component configured to implement a device function.

In some embodiments, a computer-readable storage medium is further provided. The computer-readable storage medium stores at least one piece of program code, and the program code is loaded and executed by a processor to cause a computer to implement any one of the foregoing control methods.

In some embodiments, the computer-readable storage medium may be a read-only memory (ROM), a random access memory (RAM), a compact disc read-only memory (CD-ROM), a magnetic tape, a floppy disk, an optical data storage device, or the like.

In some embodiments, a computer program or a computer program product is further provided. The computer program or the computer program product stores at least one computer instruction, the at least one computer instruction being loaded and executed by a processor, to cause a computer to implement any one of the foregoing control methods.

Information (including but not limited to user equipment information and user personal information), data (including but not limited to data for analysis, storage, and display), and signals mentioned in some embodiments are obtained under appropriate authorization from users or all relevant parties, and the collection, use, and processing of relevant data must comply with applicable laws, regulations, and standards of relevant countries and regions. For example, the game imagery mentioned in some embodiments is obtained under full authorization.

“Plurality of” mentioned in the disclosure means two or more. “And/or” describes an association relationship for describing associated objects and indicates that three relationships may exist. For example, A and/or B may indicate the following three cases: Only A exists, both A and B exist, and only B exists. The character “/” generally indicates an “or” relationship between the associated objects.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A control method of a terminal device, the method comprising:
displaying a virtual environment picture including a direction control for controlling movement of a virtual object in a virtual environment, the direction control being displayed in a first display mode corresponding to a non-static step moving mode of the virtual object in the virtual environment; and
based on determining that an operation distance derived from a target gesture operation applied via the direction control is not greater than a static step range threshold, displaying the direction control in an adjusted display mode in response to the target gesture operation, the adjusted display mode corresponding to a static step moving mode of the virtual object in the virtual environment.

2. The control method according to claim 1, wherein the adjusted display mode of the direction control is determined based on the operation distance.

3. The control method according to claim 2, wherein the displaying the direction control in the adjusted display mode comprises:
based on the operation distance not being greater than a distance threshold that is less than the static step range threshold, displaying the direction control in a second display mode corresponding to the static step moving mode;
based on the operation distance being greater than the distance threshold and less than the static step range threshold, displaying the direction control in a fourth display mode provided to transition between the second display mode and a third display mode; and
based on the operation distance being equal to the static step range threshold, displaying the direction control in the third display mode and indicating that the static step moving mode will change.

4. The control method according to claim 3, wherein the displaying the direction control in the adjusted display mode further comprises:
displaying the direction control in the second display mode based on the operation distance not being greater than the distance threshold;
displaying the direction control in the third display mode based on the operation distance being equal to the static step range threshold; and
based on the operation distance being greater than the distance threshold and less than the static step range threshold, displaying the direction control in the fourth display mode, wherein the fourth display mode transitions toward the second display mode as the operation distance decreases toward the distance threshold, and the fourth display mode transitions toward the third display mode as the operation distance increases toward the static step range threshold.

5. The control method according to claim 3, wherein the displaying of the direction control in the adjusted display mode further comprises:
based on the operation distance not being greater than the distance threshold and being less than the static step range threshold, displaying at least a portion of the direction control in: (i) a first color for the second display mode, (ii) a second color for the third display mode, and (iii) a gradient color between the first color and the second color that varies with the operation distance for the fourth display mode;
based on the operation distance not being greater than the distance threshold and being less than the static step range threshold, displaying the direction control in: (i) a first shape for the second display mode, (ii) a second shape for the third display mode, and (iii) a gradient shape between the first shape and the second shape that varies with the operation distance for the fourth display mode; and
based on the operation distance not being greater than the distance threshold and being less than the static step range threshold, displaying in the region in which the direction control is located: (i) a first pattern for the second display mode, (ii) a second pattern for the third display mode, and (iii) a gradient pattern between the first pattern and the second pattern that varies with the operation distance for the fourth display mode.

6. The control method according to claim 1, wherein the control method further comprises:
displaying a static step indicator in the virtual environment picture in response to the target gesture operation, the static step indicator indicating that the moving mode of the virtual object in the virtual environment is the static step mode.

7. The control method according to claim 6, wherein based on the direction control being displayed in the adjusted display mode, displaying the static step indicator in the virtual environment picture with the same display mode as the adjusted display mode of the direction control.

8. The control method according to claim 6, wherein the control method further comprises:
based on the target gesture operation and the operation distance not being greater than the static step range threshold, determining a display location of the static step indicator, and
wherein the displaying the static step indicator in the virtual environment picture comprises displaying the static step indicator at the display location in the virtual environment picture.

9. The control method according to claim 8, wherein the determining of the display location of the static step indicator based on the target gesture operation comprises:
based on the direction control being a fixed direction control and the target gesture operation being a first trigger operation, determining a first ray that passes through a location corresponding to the first trigger operation and that uses a center of the direction control as a starting point; and
determining a first point on the first ray as the display location of the static step indicator such that a distance between the first point and a second point at an intersection of the first ray and the direction control satisfies a distance requirement, wherein the first point is positioned at a different location than the direction control.

10. The control method according to claim 8, wherein the determining of the display location of the static step indicator based on the target gesture operation comprises:
based on the direction control being a follower direction control and the target gesture operation comprising a continuous gesture operation with a second trigger operation and a sliding operation after the second trigger operation, determining a second ray having a location corresponding to the second trigger operation as a starting point, the second ray passing through a location corresponding to the sliding operation;
determining a third ray parallel to the second ray, the third ray having a starting point corresponding to a center of the direction control; and
determining a third point on the third ray as the display location of the static step indicator such that a distance between the third point and a fourth point at an intersection of the third ray and the direction control satisfy a distance requirement, wherein the third point is positioned at a different location than the direction control.

11. A control apparatus, the apparatus comprising:
at least one memory configured to store program code; and
at least one processor configured to read the program code and operate as instructed by the program code, the program code comprising:
first display code configured to cause at least one processor of the at least one processor to display a virtual environment picture including a direction control for controlling movement of a virtual object in a virtual environment, the direction control being displayed in a first display mode corresponding to a non-static step moving mode of the virtual object in the virtual environment; and
second display code configured to cause at least one processor of the at least one processor to, based on determining that an operation distance derived from a target gesture operation applied via the direction control is not greater than a static step range threshold, display the direction control in an adjusted display mode in response to the target gesture operation, the adjusted display mode corresponding to a static step moving mode of the virtual object in the virtual environment.

12. The control apparatus according to claim 11, wherein the program code further comprises adjustment code configured to cause at least one of the at least one processor to determine the adjusted display mode of the direction control based on the operation distance.

13. The control apparatus according to claim 12, wherein the second display code is configured to cause at least one of the at least one processor to:
based on the operation distance not being greater than a distance threshold that is less than the static step range threshold, display the direction control in a second display mode corresponding to the static step moving mode;
based on the operation distance being greater than the distance threshold and less than the static step range threshold, display the direction control in a fourth display mode provided to transition between the second display mode and a third display mode; and
based on the operation distance being equal to the static step range threshold, display the direction control in the third display mode and indicate that the static step moving mode will change.

14. The control apparatus according to claim 13, wherein the second display code is configured to cause at least one of the at least one processor to:
display the direction control in the second display mode based on the operation distance not being greater than the distance threshold;
display the direction control in the third display mode based on the operation distance being equal to the static step range threshold; and
based on the operation distance being greater than the distance threshold and less than the static step range threshold, display the direction control in the fourth display mode, wherein the fourth display mode transitions toward the second display mode as the operation distance decreases toward the distance threshold, and the fourth display mode transitions toward the third display mode as the operation distance increases toward the static step range threshold.

15. The control apparatus according to claim 13, wherein the second display code is configured to cause at least one of the at least one processor to:
based on the operation distance not being greater than the distance threshold and being less than the static step range threshold, display at least a portion of the direction control in: (i) a first color for the second display mode, (ii) a second color for the third display mode, and (iii) a gradient color between the first color and the second color that varies with the operation distance for the fourth display mode;
based on the operation distance not being greater than the distance threshold and being less than the static step range threshold, display the direction control in: (i) a first shape for the second display mode, (ii) a second shape for the third display mode, and (iii) a gradient shape between the first shape and the second shape that varies with the operation distance for the fourth display mode; and
based on the operation distance not being greater than the distance threshold and being less than the static step range threshold, display in the region in which the direction control is located: (i) a first pattern for the second display mode, (ii) a second pattern for the third display mode, and (iii) a gradient pattern between the first pattern and the second pattern that varies with the operation distance for the fourth display mode.

16. The control apparatus according to claim 11, wherein the program code further comprises indicator code configured to cause at least one of the at least one processor to display a static step indicator in the virtual environment picture in response to the target gesture operation, the static step indicator indicating that the moving mode of the virtual object in the virtual environment is the static step mode.

17. The control apparatus according to claim 16, wherein the indicator code is configured to cause at least one of the at least one processor to, based on the direction control being displayed in the adjusted display mode, display the static step indicator in the virtual environment picture with the same display mode as the adjusted display mode of the direction control.

18. The control apparatus according to claim 16, wherein the program code further comprises location determination code configured to cause at least one of the at least one processor to:
based on the target gesture operation and the operation distance not being greater than the static step range threshold, determine a display location of the static step indicator; and
display the static step indicator at the display location in the virtual environment picture.

19. The control apparatus according to claim 18, wherein the location determination code is configured to cause at least one of the at least one processor to, based on the direction control being a fixed direction control and the target gesture operation comprising a first trigger operation:
determine a first ray that passes through a location corresponding to the first trigger operation and that uses a center of the direction control as a starting point; and
determine a first point on the first ray as the display location of the static step indicator such that a distance between the first point and a second point at an intersection of the first ray and the direction control satisfies a distance requirement, wherein the first point is positioned at a different location than the direction control.

20. A non-transitory computer-readable storage medium, storing computer code which, when executed by at least one processor, causes the at least one processor to at least:
display a virtual environment picture including a direction control for controlling movement of a virtual object in a virtual environment, the direction control being displayed in a first display mode corresponding to a non-static step moving mode of the virtual object in the virtual environment; and
based on determining that an operation distance derived from a target gesture operation applied via the direction control is not greater than a static step range threshold, display the direction control in an adjusted display mode in response to the target gesture operation, the adjusted display mode corresponding to a static step moving mode of the virtual object in the virtual environment.
